(19) United States
(12) Patent Application Publication
(10) Pub. No.: US 2023/0373734 A1
(43) Pub. Date: Nov. 23, 2023

(54) MECHANICAL HANDLING DEVICE FOR PHARMACEUTICAL CONTAINERS, AND HANDLING SYSTEM

(71) Applicant: Bausch + Ströbel SE + Co. KG, Ilshofen (DE)

(72) Inventors: Michael Martin Waizenhoefer, Stimpfach (DE); Florian Boerret, Gaildorf (DE); Daniel Prozer, Groeningen (DE)

(21) Appl. No.: 18/339,369

(22) Filed: Jun. 22, 2023

Related U.S. Application Data
(63) Continuation of application No. PCT/EP2021/087269, filed on Dec. 22, 2021.

(30) Foreign Application Priority Data
Dec. 23, 2020 (DE) 10 2020 134 787.1

(51) Int. Cl. B65G 47/90

(52) U.S. Cl. CPC B65G 47/90; B65G 2201/0235

(57) ABSTRACT

A mechanical handling apparatus for pharmaceutical packaging, for example for pharmaceutical containers for syringes, vials, or carpules, and a handling system with such a handling apparatus. The handling apparatus has two or more segments movable relative to one another on at least one joint device, at least one drive device for moving the two or more segments relative to one another, and a handling tool for handling the packaging. The segments have a start segment that is fixed or fixable on a holding apparatus for the handling apparatus, and an end segment on which the handling tool is held or which includes the handling tool. The handling apparatus has at least one line which is guided through at least two segments of the two or more segments and at least one joint device to the handling tool.

### CROSS-REFERENCE TO RELATED APPLICATIONS

This application is a continuation patent application of international application number PCT/EP2021/087269, filed on Dec. 22, 2021, and claims the benefit of German application number 10 2020 134 787.1, filed Dec. 23, 2020. The contents of international application number PCT/EP2021/087269 and German application number 10 2020 134 787.1 are incorporated herein by reference in their entireties and for all purposes.

### FIELD

The present disclosure relates to a mechanical handling apparatus for pharmaceutical packaging means, for example pharmaceutical containers such as syringes, vials, or carpules, comprising two or more segments which can be moved relative to one another on at least one joint device, at least one drive device for moving the two or more segments relative to one another, and a handling tool for handling the packaging means, wherein the segments comprise a start segment which is fixed or can be fixed on a holding apparatus for the handling apparatus, as well as an end segment on which the handling tool is held or which comprises the handling tool.

Furthermore, the present disclosure relates to a handling system for pharmaceutical packaging means, for example pharmaceutical containers such as syringes, vials, or carpules, comprising at least one handling apparatus of the aforementioned type and a holding apparatus on which the handling apparatus is held.

### BACKGROUND

The handling apparatus and the handling system are used in particular in a plant for processing pharmaceutical packaging means. Pharmaceutical packaging means include in particular pharmaceutical containers, for example syringes, vials, or carpules. Containers can also be referred to as “vessels.” Vials may also be referred to as “bottles” or “phials.” In the present case, carriers for individual containers or a plurality of containers can in particular also be regarded as packaging means. For example, carriers referred to as a nest are known for receiving containers arranged in a matrix-like manner. For example, a so-called tray can be regarded as a different type of packaging means in which containers are arranged positioned flat next to one another. In the plant, the pharmaceutical containers are typically filled with a liquid or solid pharmaceutical substance and subsequently closed. The pharmaceutical substance is in particular a medically active substance (agent). The handling apparatus can be used to transfer the packaging means, for example. For example, the containers are transferred from a common carrier (nest or tray) to a transport system. Alternatively or additionally, the containers can be filled with the substance via the handling apparatus. Packaging means such as nests or trays can be transferred, for example, by the handling apparatus.

In the present example, “handling” can occur directly or indirectly. This can be understood in particular as meaning that the packaging means can come into contact with the handling tool or are free of contact with the handling tool.

An object underlying the present disclosure is to provide a handling apparatus and a handling system which have an increased operational reliability.

### SUMMARY

In a first aspect of the present disclosure, a mechanical handling apparatus for pharmaceutical packaging means, for example for pharmaceutical containers, is provided. The handling apparatus comprises two or more segments movable relative to one another on at least one joint device, at least one drive device for moving the two or more segments relative to one another, and a handling tool for handling the packaging means. The segments comprise a start segment which is fixed or is configured to be fixed on a holding apparatus for the handling apparatus, as well as an end segment on which the handling tool is held or which comprises the handling tool. The handling apparatus comprises at least one line which is guided through at least two segments of the two or more segments and at least one joint device to the handling tool.

In a second aspect of the present disclosure, a handling system for pharmaceutical packaging means, for example for pharmaceutical containers is provided. The handling system comprises at least one handling apparatus in accordance with the first aspect and a holding apparatus on which the handling apparatus is held. The holding apparatus comprises or forms a separating element and defines a first zone and a second zone which are separated from one another by means of the separating element. The handling tool is arranged in the second zone and the at least one line is guided from the first zone into the second zone through at least one through-opening in the separating element.

### BRIEF DESCRIPTION OF THE DRAWINGS

The foregoing summary and the following description may be better understood in conjunction with the drawing figures, of which:

FIG. 1 is a plan view of a handling system in accordance with the present disclosure in a partial representation, configured as a gripping system;

FIG. 2 is a schematic partial representation of the handling system of FIG. 1, partially cut, with a handling apparatus in accordance with the present disclosure;

FIG. 3 is a perspective representation of the handling apparatus of FIG. 2;

FIG. 4 is an enlarged representation of detail A in FIG. 2;

FIG. 5 is a plan view of a handling system in accordance with the present disclosure, configured as a filling system, in a partial representation;

FIG. 6 is a perspective view of a handling apparatus of the handling system of FIG. 5; and

FIG. 7 is a schematic sectional view of the handling apparatus of FIG. 6 in a partial representation;

FIG. 8 is a perspective representation of another handling apparatus in a manner corresponding to FIGS. 3 and 6;

FIG. 9 is a perspective representation of another handling apparatus in a manner corresponding to FIGS. 3 and 6; and

FIG. 10 is a perspective representation of another handling apparatus in a manner corresponding to FIGS. 3 and 6.

### DETAILED DESCRIPTION

Although the present disclosure is illustrated and described herein with reference to specific embodiments, the present disclosure is not intended to be limited to the details shown. Rather, various modifications may be made in the details within the scope and range of equivalents and without departing from the present disclosure.

The present disclosure relates to a mechanical handling apparatus for pharmaceutical packaging means, for example pharmaceutical containers such as syringes, vials, or carpules, comprising two or more segments which can be moved relative to one another on at least one joint device, at least one drive device for moving the two or more segments relative to one another, and a handling tool for handling the packaging means, wherein the segments comprise a start segment which is fixed or can be fixed on a holding apparatus for the handling apparatus, as well as an end segment on which the handling tool is held or which comprises the handling tool, wherein the handling apparatus comprises at least one line which is guided through at least two segments of the two or more segments and at least one joint device to the handling tool.

In the handling apparatus in accordance with the present disclosure, at least one line is guided at least in sections through two or more segments and at least one joint device to the handling tool. An intended effect for handling the packaging means with the handling tool can be influenced by the at least one line. For example, the handling tool can be actuated with regard to the task to be accomplished. The feed-through of the at least one line can prove advantageous, for example, in a pharmaceutically compliant environment and in particular an atmosphere of the handling apparatus. When handling pharmaceutical packaging means, the handling apparatus is, for example, at least partially arranged in a protective atmosphere. “Protective atmosphere” in the present case can comprise in particular an atmosphere for decontamination purposes. The protective atmosphere can in particular comprise a flow of H₂O₂ applied to the outside of the handling apparatus. By positioning the at least one line at least partially within the segments, the line is protected from the protective atmosphere, whereby, for example, damage to the line can be avoided. Furthermore, the at least one line within the segments is protected against collision with additional components of the handling system or the plant and/or against unintentional intervention by a user. Overall, the operational safety can be increased by the configuration of the handling apparatus in accordance with the present disclosure.

It can be provided that the handling tool forms the end segment.

It is advantageous if the at least one line is guided through the two or more segments from the start segment to the end segment. In particular, the at least one line can be guided through the entire handling apparatus to the handling tool.

The handling apparatus is characterized, in particular, by a pharmaceutically compliant design, specifically by means of a pharmaceutically compliant seal in the region of at least one joint device between two segments connected to one another in an articulated manner.

In the present case, “pharmaceutically compliant” can in particular be a design of the handling apparatus which meets the requirements for resistance to a protective atmosphere, for resistance to possible toxic substances to be processed, for cleanability, for use in a clean room and/or for at least one other property that allow proper and approved processing of pharmaceutical packaging means. In this case, the handling apparatus is preferably designed to be pharmaceutically compliant at least in a region of the handling system that can be exposed to a protective atmosphere. This region is also referred to below as “second zone.”

A pharmaceutically compliant design can be achieved, for example, by preferably manufacturing components of the handling apparatus from stainless steel, at least on a side that can be exposed to a protective atmosphere. For example, stainless steel of the compositions 1.4435, 1.4404, or 1.4301 is used.

In the present case, the handling apparatus can be regarded as “mechanical” in particular as a result of the presence of the at least one drive device by which two segments are connected to one another in an articulated manner.

In a preferred embodiment of the present disclosure, the at least one joint device is a pivot device, wherein the segments can be pivoted relative to one another about a pivot axis by the drive device. In the present case, the pivot axis is oriented, for example, transversely and in particular perpendicularly to a plane defined by the holding apparatus, for example a plane of a support element. For example, the pivot axis is oriented vertically.

In the present case, “pivoting” can, in particular, also mean “rotating.”

In a preferred embodiment, the handling apparatus advantageously comprises more than two segments, wherein two segments are each movably connected to one another by a respective drive device on a joint device.

It may be provided that two or more joint devices are configured as pivot devices, wherein two or more corresponding pivot axes of the pivot devices are oriented in parallel to one another. Alternatively or additionally, for example, two pivot axes may be oriented transversely and in particular perpendicularly to one another.

In a preferred embodiment of the present disclosure, the handling apparatus comprises, for example, three segments, wherein the start segment can be pivoted relative to a middle segment, which in turn can be pivoted relative to the end segment.

The handling apparatus, in particular in the last-mentioned advantageous embodiment of the present disclosure, is, for example, a Scara robot or comprises or forms a Scara robot. In the present case, a Scara robot is in particular considered to be an articulated arm robot, specifically a horizontal articulated arm robot.

In a preferred embodiment of the present disclosure, the handling tool is a gripping tool comprising at least one gripping element for gripping a pharmaceutical packaging means. For example, the packaging means can be transferred by means of the handling apparatus from a first position to a second position (pick-and-place). It is conceivable, for example, that containers, a nest, or a tray are transferred. Alternatively, containers can be removed, for example, from another packaging means, in particular the tray or the nest, or inserted into the further packaging means. The gripping device can preferably comprise a plurality of gripping elements in order to be able to handle a plurality of packaging means together and/or simultaneously with one another.

In a preferred embodiment of the present disclosure, the handling tool is a filling tool which comprises at least one filling element for filling a substance into a pharmaceutical container.

The at least one filling element is, for example, a needle which can be inserted into an opening of the container, wherein the substance is filled into the container by the needle. The filling device preferably comprises a plurality of filling elements in order to be able to fill a plurality of containers simultaneously.

It is understood that the gripping elements and/or the filling elements are advantageously configured identically.

The at least one line can advantageously comprise, be or form at least one of the following:
an electrical line for supplying energy and/or for controlling a drive device of the handling tool. For example, electrical energy is applied to the drive device, and/or control signals are provided for the drive device via the line.
a feed line through which a substance for filling into the containers can be fed. For example, the substance is fed to the aforementioned filling element, wherein the feed line is connected, for example, to the filling element.
a fluid line for applying negative pressure to the packaging means. For example, the fluid line is arranged on a gripping element so that the packaging means can be held on the gripping element by means of negative pressure provided by the fluid line. Conversely, the application of negative pressure to the fluid line can be terminated and/or the fluid line can be ventilated in order to detach the packaging means from the gripping element.
In a different embodiment of the fluid line, the interior of the container can be at least partially evacuated, for example.
a fluid line for discharging a fluid from the handling tool. In this way, for example, gas can be discharged from the handling tool, especially with regard to a sterile, pharmaceutically compliant atmosphere.

In the present case, “fluid” can in particular be a gas or a liquid. In the present case, this is also understood to mean a gas mixture or a liquid mixture.

When using a gripping tool, the at least one fluid line can in particular be a pneumatic line which can be subjected to negative pressure to hold the packaging means on the gripping element. When a filling tool is used, the at least one feed line can in particular be designed for feeding a liquid substance.

When a gripping tool is used, it is in particular provided that the gripping tool has a contour that is adapted to a contour of the packaging means. For example, the gripping tool has a recess into which a container can be at least partially inserted in order to be applied to a portion of the gripping tool. In this case, the container is held on the gripping element, for example, by negative pressure, in particular pneumatically. The gripping element abuts, for example, against a jacket of the container.

For handling nests or trays, it can be provided, for example, that the handling tool has a suction body with an edge that can be placed onto an edge of the nest or tray. It may be provided that the gripping tool abuts against the packaging means at one point or linearly or flatly.

The at least one line can be of different designs. In the configuration as a fluid line or feed line, the at least one line is, for example, a hose line. The hose line can, for example, be manufactured from a plastics material, for example a silicone material. In the configuration as an electrical line, the at least one line in particular is or comprises a cable.

The at least one line is preferably configured to be deformable, at least in the portion extending through the segments.

Two or more lines can, for example, extend together at least in sections in a sheath.

It can be provided that the at least one line extends through the two or more segments of the handling apparatus, which line branches into a plurality of individual lines, for example in the handling tool. For example, for applying negative pressure, a fluid line is conceivable that branches into a plurality of portions in the handling tool, wherein each portion is arranged on a gripping element.

When providing filling elements of a filling tool, it may be advantageous if feed lines for feeding the substance are guided separately through the handling apparatus.

It may be provided that the at least one line on the end segment extends completely within the handling tool.

Alternatively, it may be provided that the at least one line exits from the end segment and extends in sections outside the handling tool.

It is advantageous if at least one segment is a hollow shaft or comprises a hollow shaft through which the at least one line is guided. For example, the start segment is or comprises the hollow shaft which, in a preferred embodiment, can be movably fixed to the holding apparatus. For example, the hollow shaft can be rotated and/or translationally displaced relative to the holding apparatus. The hollow shaft can define or comprise an axis of rotation about which the relevant segment can be rotated.

It can be advantageous if at least one segment comprises or forms a housing with a receiving space through which at least one line is guided in the direction of the end segment and in which the at least one drive device is arranged, via which drive device two or more segments are movable relative to one another. The at least one additional line is, for example, an electrical line for supplying energy and/or for controlling the drive device.

In the last-mentioned advantageous embodiment, the handling apparatus preferably comprises at least one additional line which is operatively connected to the at least one drive device. The additional line is preferably guided through the start segment and optionally at least one additional segment to the drive device. The advantages which have already been explained in connection with guiding the at least one line through to the handling tool can also be achieved with the additional line.

The handling apparatus can advantageously comprise a drive device by which at least one segment is translationally movable. Preferably, the start segment is translationally movable, wherein the drive device is arranged on the holding apparatus.

The drive device is provided, for example, for raising and lowering the start segment. In a preferred embodiment, the drive device comprises, for example, a spindle drive.

As already mentioned, the present disclosure further relates to a handling system for pharmaceutical packaging means, for example for pharmaceutical containers.

A handling system in accordance with the present disclosure, which achieves the aforementioned object, comprises at least one handling apparatus of the type described above and a holding apparatus on which the handling apparatus is held, wherein the holding apparatus comprises or forms a separating element and defines a first zone and a second zone which are separated from one another by means of the separating element, wherein the handling tool is arranged in the second zone and the at least one line is guided from the first zone into the second zone through at least one through-opening in the separating element.

The advantages mentioned in connection with the explanation of the handling apparatus in accordance with the present disclosure can also be achieved with the handling system. The separating element separates the first zone from the second zone, wherein the second zone is in particular exposed to a protective atmosphere. The handling apparatus is preferably configured to be pharmaceutically compliant at least in the second zone. The at least one line is guided through the through-opening into the first zone. The zones are preferably separated from one another in a pharmaceutically compliant manner.

Preferably, the start segment extends through the at least one through-opening and is arranged in each case in sections in the first zone and in the second zone. The start element is preferably movably fixed to the separating element by means of a holding element. The holding element is or comprises, for example, a guide on the separating element for guiding a rotational movement and/or a translational movement of the start segment relative to the separating element. At least one bearing element may preferably be effective between the holding element and the start segment. The start segment is preferably fixed in a stationary manner in the first zone.

The holding element can be part of the handling apparatus or part of the holding apparatus.

It has proven advantageous if the holding apparatus forms a substructure for the handling apparatus, wherein the separating element is or forms a support element. The support element is, for example, at least partially plate-shaped and can, for example, be a tabletop or the like. The substructure can be formed, for example, by a frame on which the handling apparatus is fixed.

For example, the first zone is arranged below the separating element, and the second zone is arranged above the separating element.

Position and orientation information such as “below” and “above” refer in the present case to proper use of the handling system. The holding apparatus is positioned in particular on a floor of a laboratory or hall.

In the first zone, at least one drive device is, for example, arranged for rotating and/or for translationally moving the handling apparatus relative to the holding apparatus.

In the first zone, at least one pressure-generating device and/or valve device for providing a positive pressure and/or negative pressure through at least one line is, for example, arranged on the handling tool.

For example, at least one metering device for a substance is arranged in the first zone and can be filled into the containers through at least one line.

For example, at least one electric device for providing an energy supply and/or for controlling at least one drive device of the handling apparatus is arranged in the first zone.

The handling system preferably comprises a covering device which covers from above and/or laterally covers the handling apparatus in the second zone and provides a protective atmosphere in the second zone. The covering device can, for example, be a so-called isolator with which a flow of protective gas, in particular H₂O₂, can be provided in the second zone, in particular with regard to a pharmaceutically compliant environment.

In a preferred embodiment, the handling system is a gripping system, wherein the handling tool is a gripping tool.

In a preferred embodiment, the handling system can be a filling system, wherein the handling tool is a filling tool.

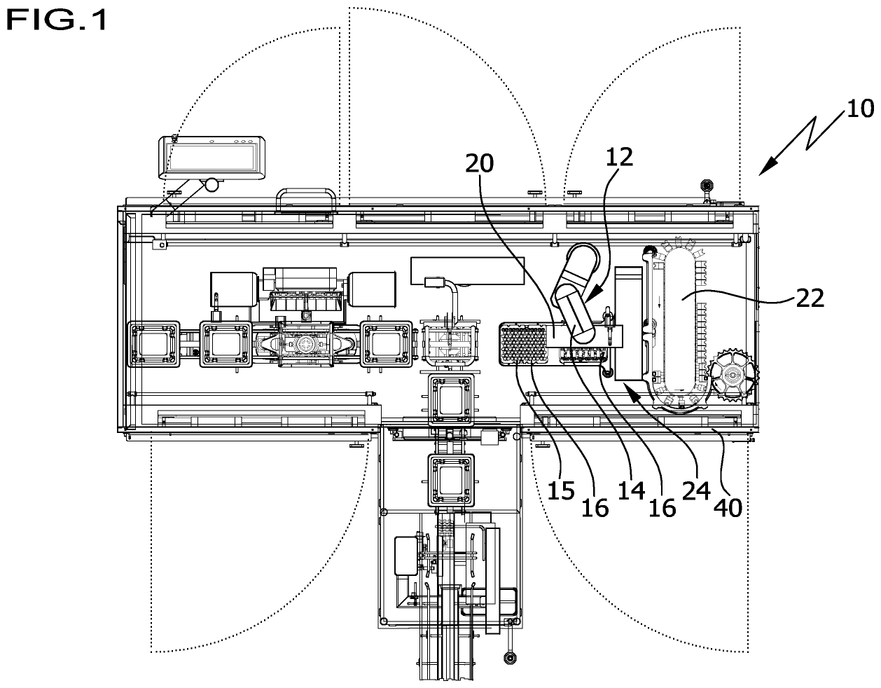

FIG. 1 shows a plan view of an advantageous embodiment of a handling system in accordance with the present disclosure, configured as a gripping system, denoted by reference numeral 10. The handling system 10 comprises an advantageous embodiment of a handling apparatus in accordance with the present disclosure, denoted by reference numeral 12. The handling apparatus 12 is mechanical and configured in particular as a Scara robot 14. In the present exemplary embodiment, it is in particular a horizontal articulated arm robot.

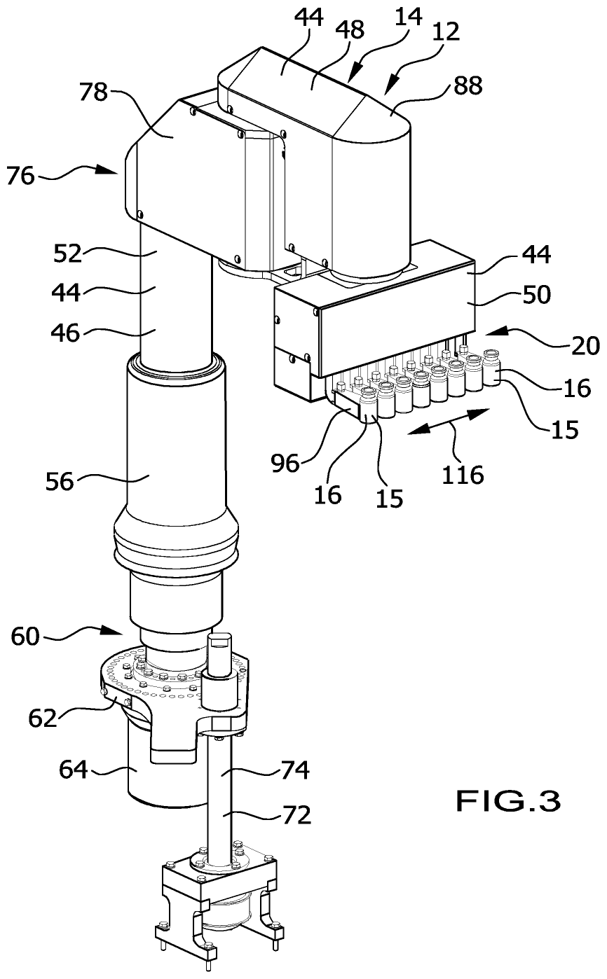

The handling system 10 is part of a plant for processing pharmaceutical packaging means 15. In the following exemplary embodiment, the packaging means are pharmaceutical containers, for example vials, syringes, and/or carpules. By way of example, FIG. 3 shows containers 16 in the form of vials. In the plant, the containers 16 can, for example, be transferred by means of the handling apparatus 12 to a transport system, filled, closed, labeled, and subsequently placed in a carrier for removal.

In the handling system 10, the Scara robot 14 is used to remove the containers 16 from a common carrier 18. For this purpose, the containers 16 are drawn, as explained below, against a handling tool 20 by means of negative pressure, lifted out of the carrier 18 and transferred to a transport device 22 by ending the application of negative pressure to the handling tool 20.

The handling system 10 comprises a holding apparatus 24 for the handling apparatus 12. The holding apparatus 24 comprises a frame 28 which is arranged on a floor 26 of a laboratory or the like and forms a substructure 30. The substructure 30 comprises a separating element 32 which in the present case forms a plate-shaped support element 34. For example, the support element 34 is a tabletop or the like of the frame 28.

The separating element 32 separates a first zone 36 of the handling system 10 and a second zone 38 from one another. The zones 36, 38 are arranged on opposite sides of the support element 34. In this case, the second zone 38 is defined above and the first zone 36 is defined below the support element 34. Additional components of the handling system 10 can be placed on the support element 34 (FIG. 1), for example.

The handling system 10 comprises a covering device 40 which covers the handling apparatus 12 in the second zone 38 and laterally covers, for example, at an edge of the frame 28. The covering device 40 is configured to provide a protective atmosphere in the second zone 38. This protective atmosphere can, for example, be or comprise an atmosphere for decontamination purposes. The protective atmosphere comprises in particular a flow 42 of a protective gas, in the present case H₂O₂, for flowing around the handling apparatus 12 in the second zone 38.

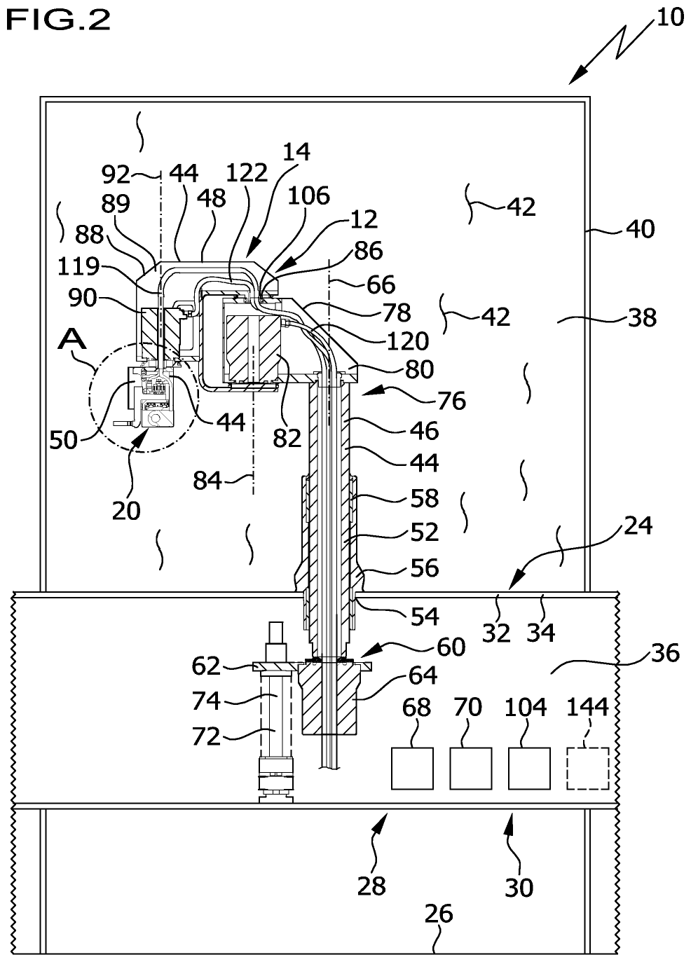

The covering device 40 is in particular a so-called isolator, which is shown only schematically in FIG. 2.

The handling apparatus 12 is, at least in the region arranged in the second zone 38, designed to be pharmaceutically compliant, specifically for use in the protective atmosphere. In particular, joint devices mentioned below and/or the handling tool 20 are sealed in a pharmaceutically compliant manner. A pharmaceutically compliant design can also be achieved, for example, by manufacturing components of the handling apparatus 12 from stainless steel on a side that can be exposed to a protective atmosphere, for example stainless steel of the compositions 1.4435, 1.4404, or 1.4301.

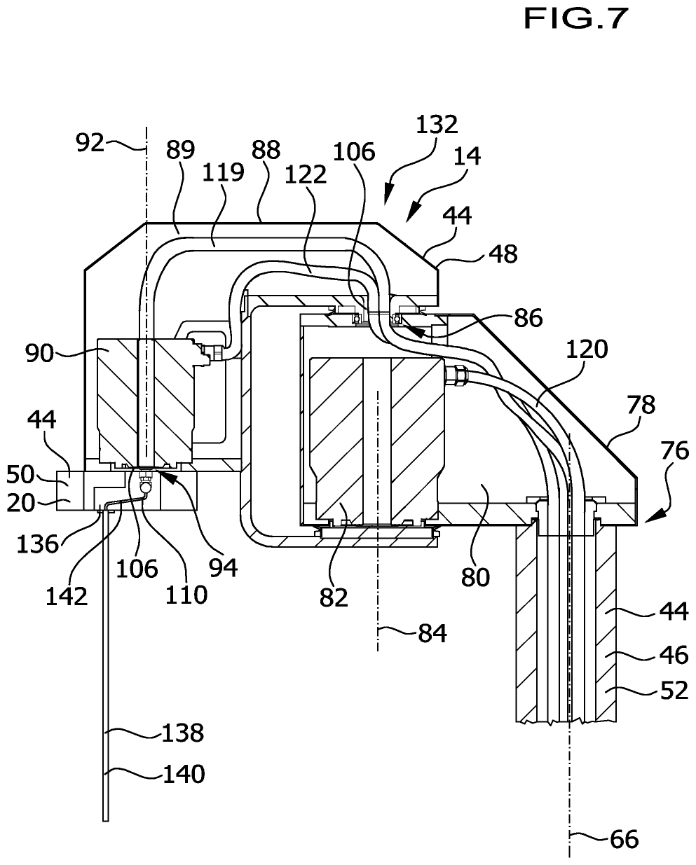

In the following, with reference in particular initially to FIGS. 2 and 3, the nature of the handling apparatus 12 is discussed, referred to below as a robot 14. In addition to FIG. 2, reference is made to FIG. 7 with respect to the internal structure of the robot 14.

The robot 14 comprises a plurality of segments 44 which are movable relative to one another by means of drive devices on joint devices. The segments 44 comprise a start segment 46, a middle segment 48, and an end segment 50.

The start segment 46 extends by a hollow shaft 52 through a through-opening 54 in the support element 34. In this way, the start segment 46 projects from the first zone 36 into the second zone 38 and is partially arranged in both zones 36, 38.

The robot 14 comprises a holding element 56 which in the present case is fixed on the support element 34 in the second zone 38. The holding element 56 forms a sleeve which surrounds the hollow shaft 52. A bearing element 58 serves for rotatably and/or displaceably mounting the hollow shaft 52 relative to the stationary holding element 56.

In particular in the region of the through-opening 54, there is a pharmaceutically compliant seal between the zones 36, 38 (FIG. 2).

A portion 60 arranged in the first zone 38 is rotatably fixed on a holding part 62. The holding part 62 is, for example, configured to be flange-like. A drive device 64 also acts on the holding part 62. By means of the drive device 64, the hollow shaft 52 and thus the start segment 46 can be rotated about an axis of rotation 66 which is an axis of the hollow shaft 52.

In the present case, the axis of rotation 66 is oriented transversely and in particular perpendicularly to a plane defined by the support element 34, in particular vertically.

An electric device 68 for providing an energy supply and for controlling the drive device 64 is arranged in the first zone 36. Furthermore, a control device 70 is present in order to control the operation of the robot 14 and preferably of the handling system 10.

The holding part 62 is held on a drive device 72. By means of the drive device 72 which can be operatively connected to the electric device 68, the hollow shaft 52 and thus the start segment 46 can be raised and lowered. In this case, the translational movement preferably takes place, in particular in the vertical direction. The drive device 72 preferably comprises or is configured as a spindle drive 74.

A portion 76 of the start segment 46 in the second zone 38 comprises a housing 78. The housing 78 is fixed on the hollow shaft 52 on the side facing away from the holding part 62 and forms a receiving space 80.

A drive device 82 is arranged in the receiving space 80. The middle segment 48 can be pivoted relative to the start segment 46 about a pivot axis 84 by means of the drive device 82. For this purpose, the start segment 46 and the middle segment 48 are connected to one another via a joint device 86.

The middle segment 48 forms a housing 88 which forms a receiving space 89. An additional drive device 90 is arranged in the receiving space 89. The drive device 90 serves to pivot the end segment 50 relative to the middle segment 48 about another pivot axis 92. For this purpose, the middle segment 48 and the end segment 50 are connected to one another via a joint device 94.

The axis of rotation 66 and the pivot axes 84, 92 are oriented in parallel to one another.

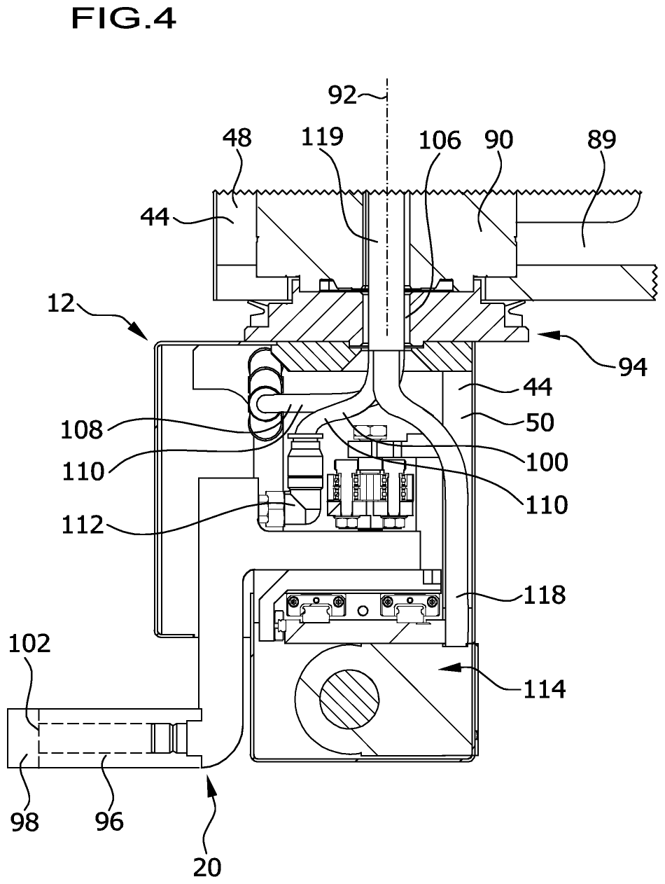

As can be seen in particular from FIGS. 3 and 4, the aforementioned handling tool 20 is held on the end segment 50. The handling tool 20 comprises at least one gripping element 96 for holding a container 16. In the present case, a plurality of gripping elements 96 is provided. For example, a respective recess 98, which is adapted to the geometry of the container 16 and into which the container 16 can be partially inserted, is arranged on the gripping element 96.

A fluid line 100 is used to apply negative pressure to the container 16 through an opening 102 in the gripping element 96 in order to hold the container 16 in the recess 98 on the gripping element 96. The gripping element 96 can, for example, abut against a jacket of the container 16.

Via a connection element 112, the fluid line 100 is connected to the gripping elements 96 and branches into individual portions. In this way, the gripping elements 96 can be subjected to negative pressure through just one fluid line 100. Negative pressure up to the opening 102 can be provided through the respective gripping element 96 (FIG. 4).

In order to provide the negative pressure, a pneumatic pressure-generating device 104 is arranged in the first zone 36. The pressure-generating device 104 generates in particular a suction air flow through the fluid line 100 and can preferably be controlled by the control device 70.

The fluid line 100 passes through the robot 14 from the handling tool 20 into the first zone 36. Thereby the fluid line 100 extends through the handling tool 20, the segments 46 to 50, and feed-throughs 106 which are respectively formed between the segments 48 and 50 or 46 and 48.

If the fluid line 100 is subjected to negative pressure, the container 16 is thereby held in the recess 98 and contacts the gripping element 96. If the negative pressure application is not applied or when the fluid line 100 is ventilated, the container 16 is detached from the gripping element 96.

Another fluid line 108 extends from the handling tool 20 through the robot 14 into the first zone 36. The fluid line 108 serves for discharging ambient air from the second zone 38, for example when the fluid line 100 is released. The fluid line 108 is provided to maintain a sterile, pharmaceutically compliant environment on the handling tool 20.

Like the fluid line 108, the fluid line 100 is configured as a hose line 110.

The handling tool 20 further comprises a drive device 114. The drive device 114 serves to change a distance of adjacent gripping elements 96 from one another. In so doing, the gripping elements 96 can be spread relative to one another or brought closer to one another (double arrow 116 in FIG. 3).

An electrical line 118 extends from the drive device 114 through the robot 14 into the first zone 36. The electrical line 118 is in particular an electrical connection cable.

It is provided that, for example, the fluid line 100, the fluid line 108 and/or the electrical line 118 extend in sections together in a sheath 119 through the robot 14.

Furthermore, the handling apparatus 12 comprises electrical lines 120 and 122. The lines 120, 122 preferably each comprise a connection cable and are connected to the drive device 82 or 90 (FIG. 2). Both lines 120, 122 extend through the robot 14 into the first zone 36.

The drive devices 82, 90, and 114 are operatively connected, for example, to the electric device 68.

Because the lines 100, 108, and 118 and the lines 120 and 122 are guided through the robot 14 into the first zone 36, they are protected from the atmosphere in the second zone 38, in particular from the H₂O₂ protective gas.

Furthermore, the lines 100, 108, 118, 120, and 122 are protected from other components of the handling system 10. A collision during the movement of the robot 14 can thereby be avoided. Additional protection exists against unintentional intervention by a user.

It is in particular advantageous that the lines 100, 108, 118, 120, and 122 extend completely within the robot 14.

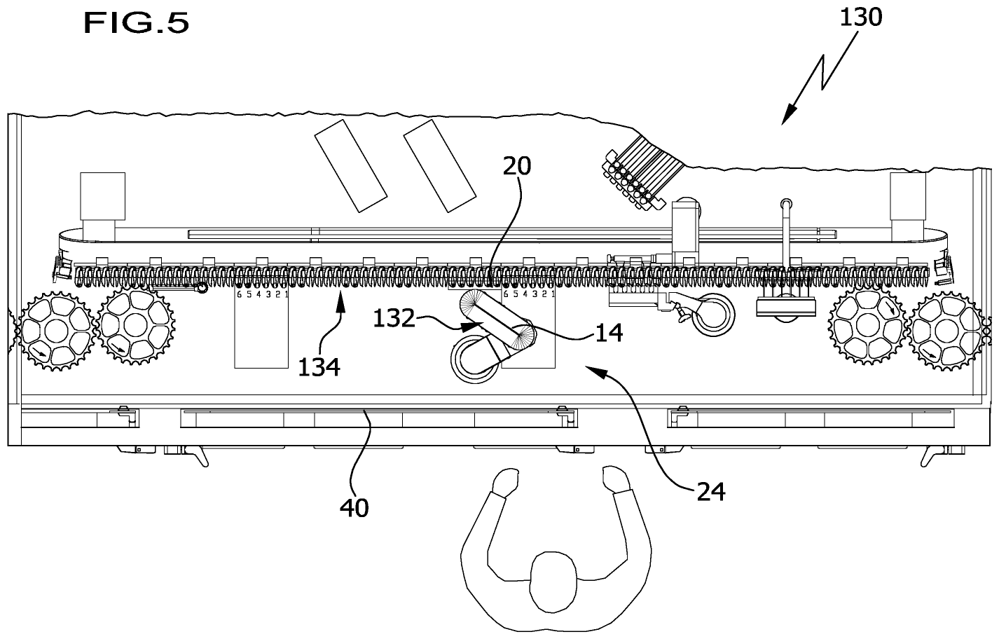

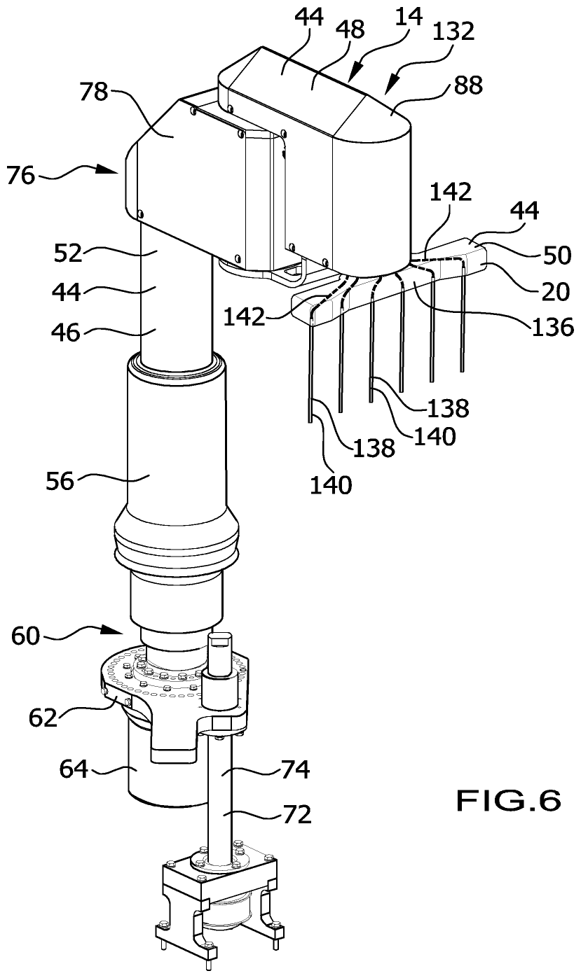

The following discusses FIGS. 5 to 7 which show a preferred embodiment of the handling system in accordance with the present disclosure, which is denoted by reference numeral 130, and a preferred embodiment of the handling apparatus in accordance with the present disclosure, which is denoted by reference numeral 132. The handling system 130 is configured as a filling system and comprises the handling apparatus 132.

Identical reference numerals are used for identical or identically acting features and components of the systems 10, 130 and apparatuses 12, 132. The advantages explained above can also be achieved with the handling system 130 and the handling apparatus 132. Only the substantial differences are therefore discussed below.

The handling system 130 is used for filling the containers 16. For example, the containers 16 (FIG. 5) are held on a transport device 134. If the containers 16 pass through the handling apparatus 132, they can be filled by it with a substance. In the present case, the substance is a liquid. However, the present disclosure can also be used for filling containers 16 with, for example, a powdery substance.

The end segment 50 in the robot 14 of the handling apparatus 132 comprises a filling tool which has a holding part 136 and filling elements 138. The filling elements 138 are configured as needles 140 which can engage in the respective container 16 through an opening in the top side. For this purpose, the start segment 46 can be lowered and raised by means of the drive device 72.

The filling elements 138 are connected to a respective feed line 142. The number of feed lines 142 corresponds to the number of filling elements 138. The feed lines 142 extend through the robot 14 to the first zone 36. In this way, the feed lines 142, like the lines described above, are protected against the protective atmosphere and against collision with obstacles. In the present case, the feed lines 142 extend in sections together in the sheath 119.

A metering device 144 is arranged in the first zone 36; the metering device 144 is shown schematically in FIG. 2. It is understood that the metering device 144 does not need to be provided in the handling system 10. The representation serves merely for illustration. The metering device 144 comprises, for example, a pump device and/or a valve device.

The substance to be filled into the containers 16 is transported by the metering device 144, which is in particular operatively connected to the control device 70, through the feed lines 142 to the needles 140 and is filled as required into the containers 16.

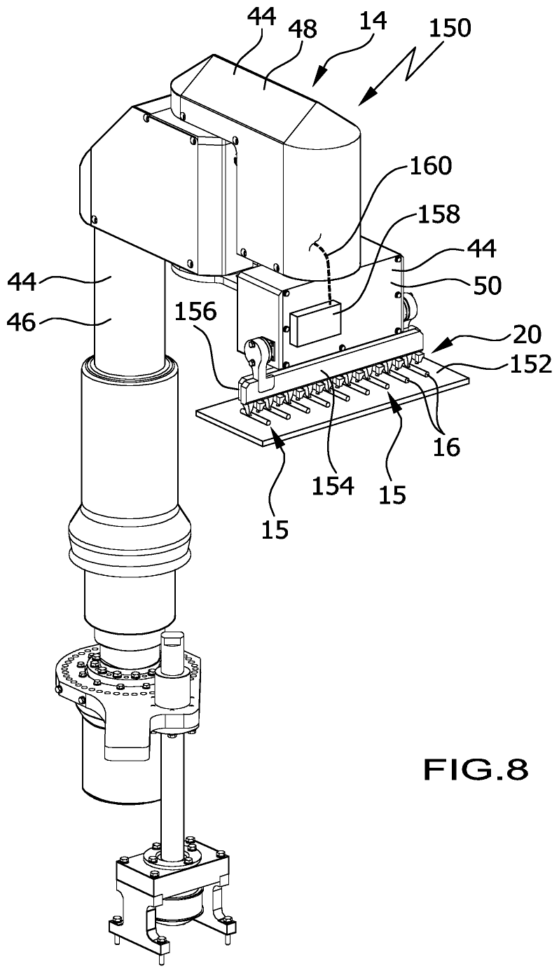

Additional preferred embodiments of the handling apparatus in accordance with the present disclosure are shown in FIGS. 8 to 10 and are denoted there by reference numerals 150, 170, and 190. Just as in the embodiment in accordance with FIGS. 5 to 7, only the substantial differences with respect to the handling apparatus 12 are mentioned.

It is understood that the handling apparatuses 150, 170, and 190 can be part of a handling system in accordance with the present disclosure. For identical or identically acting features and components, reference numerals that are already identical to the already introduced reference numerals are used.

In the handling apparatus 150 in accordance with FIG. 8, the handling tool 20 is a gripping tool for packaging means 15, in the present case in the form of containers 16 which are syringes. The containers 16 are held on a common carrier 152 configured as a tray. The carrier 152 is in turn also a packaging means 15.

The handling tool 20 is a gripping tool with two gripping elements 154, 156 movable relative to one another. Depending on the relative position of the gripping elements 154, 156, the containers 16 can be gripped and lifted from the carrier 152. For this purpose, the carrier 152 (not shown) is held in a stationary manner on a holding part, for example.

The handling apparatus 150 comprises a drive device 158. An electrical line 160 is guided from the handling tool 20 through the segments 44 and thus through the robot 14 into the substructure 30 and is operatively connected there, for example, to the electric device 68.

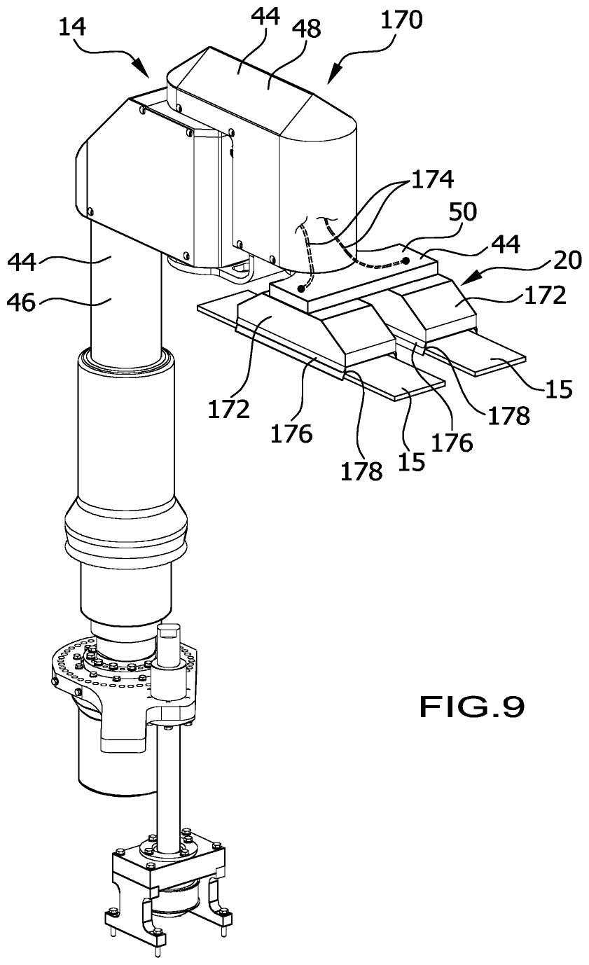

As a handling tool 20, the embodiment 170 in accordance with FIG. 9 also comprises a gripping tool for packaging means 15. In the present case, the packaging means 15 are in turn carriers 152 in the form of trays. Containers 16 (not shown in the drawing), in particular syringes, can be arranged on the carriers 152.

The handling tool 20 comprises at least one negative pressure gripping element 172. In the present case, two gripping elements 172 are arranged on the end segment 50. The gripping elements 172 are each configured in the shape of a hood and form suction bodies for drawing the carriers 152.

The gripping elements 172 can be subjected to negative pressure via a respective fluid line 174 which extends through the robot 14 into the substructure 30. For this purpose, the fluid lines 174 are connected, for example, to the pressure-generating device 104.

When negative pressure is applied, a respective edge 176 of a gripping element 172 can be placed onto an edge 178 of a carrier 152 so that a sufficient seal results for raising the carriers 152 by means of the handling tool. The carriers 152 can be set down when the negative pressure is not applied.

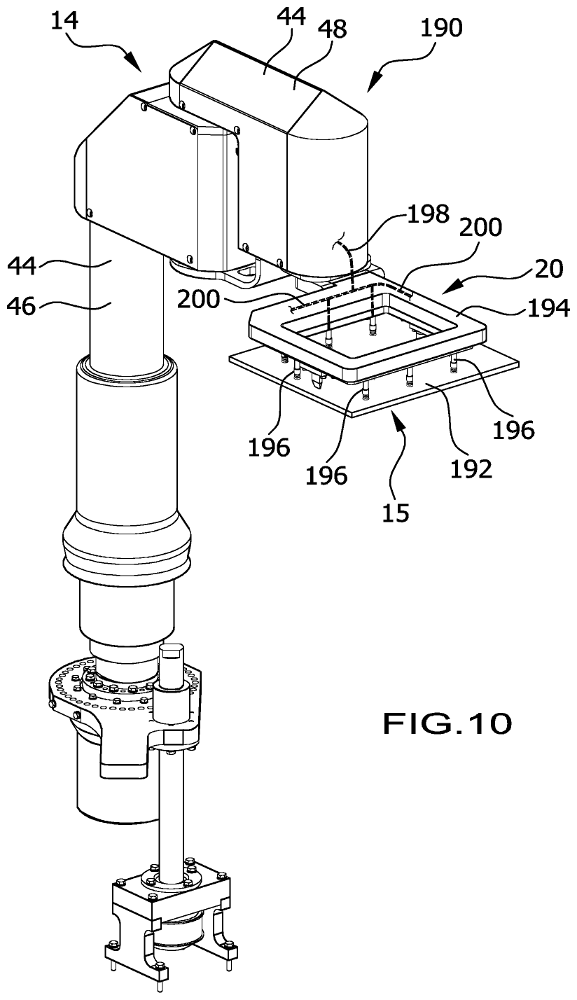

With the handling apparatus 190 in accordance with FIG. 10, the handling tool 20 is also a gripping tool. The handling tool 20 is used to transfer carriers 192, in the present case configured as a so-called nest for a plurality of containers 16 (not shown in the drawing). The containers 16, for example syringes or vials, are received in recesses formed for this purpose in the carrier 192.

The handling tool 20 comprises a frame-shaped holding part 194 arranged on the end segment. A plurality of gripping elements 196, which in the present case are designed in the form of a pin, protrude from the holding part 194. A fluid line 198 is guided through the robot 14 into the substructure 30 and is operatively connected there, for example, to a pressure-generating device 104. The fluid line 198 is a negative pressure line for applying negative pressure to the gripping elements 196.

For this purpose, the fluid line 198, in the present case in the holding part 194, branches into respective portions 200. A respective portion 200 leads to the gripping element 196.

When the negative pressure is applied, the free end of the gripping element 196 is subjected to negative pressure. When the handling tool 20 is placed onto the carrier 192, the holding force is sufficient to raise the carrier 192 in the emptied and/or filled state. Conversely, the carrier 192 can be set down when the negative pressure is not applied.

1. A mechanical handling apparatus for pharmaceutical packaging means, for example for pharmaceutical containers, comprising two or more segments movable relative to one another on at least one joint device, at least one drive device for moving the two or more segments relative to one another, and a handling tool for handling the packaging means, wherein the segments comprise a start segment which is fixed or is configured to be fixed on a holding apparatus for the handling apparatus, as well as an end segment on which the handling tool is held or which comprises the handling tool, wherein the handling apparatus comprises at least one line which is guided through at least two segments of the two or more segments and at least one joint device to the handling tool.

2.-20. (canceled)
